(19) United States
(12) Patent Application Publication
(10) Pub. No.: US 2012/0158362 A1
(43) Pub. Date: Jun. 21, 2012

(54) REMOTE ANGLE MAPPING PROCESS FOR A CPV ARRAY

(75) Inventors: Roeland Vandevelde, American Canyon, CA (US); Qiang Xie, San Jose, CA (US); Louis F. Langlois, San Francisco, CA (US)

(73) Assignee: GREENVOLTS, INC., Fremont, CA (US)

(21) Appl. No.: 13/227,662

(22) Filed: Sep. 8, 2011

Related U.S. Application Data
(60) Provisional application No. 61/424,537, filed on Dec. 17, 2010.
(60) Provisional application No. 61/424,515, filed on Dec. 17, 2010.
(60) Provisional application No. 61/424,518, filed on Dec. 17, 2010.
(60) Provisional application No. 61/424,493, filed on Dec. 17, 2010.

(51) Int. Cl. G06F 15/00

(52) U.S. Cl. 702/183

(57) ABSTRACT

Angle mapping logic for a solar array of a two-axis tracker mechanism for the concentrated photovoltaic system is configured to facilitate a remotely initiated angle mapping process and then remotely diagnose movement and other pointing errors in the solar array on the two-axis solar tracker mechanism. Deviations in power produced in a set of test points of the angle mapping process and shapes of the plotted information provide diagnostics to indicate error locations and types of pointing errors present in the equipment in the solar array and in the two-axis tracker mechanism. Information from the angle mapping process is sent over a network to a remote server for analysis. The test can be initiated from the remote server.

### RELATED APPLICATIONS

This application is a continuation in part of and claims the benefit of and priority to U.S. Provisional Application titled “Integrated electronics system” filed on Dec. 17, 2010 having application Ser. No. 61/424,537, U.S. Provisional Application titled “Two axis tracker and tracker calibration” filed on Dec. 17, 2010 having application Ser. No. 61/424,515, U.S. provisional application titled “ISIS AND WIFI” filed on Dec. 17, 2010 having application Ser. No. 61/424493, and U.S. Provisional Application titled “Photovoltaic cells and paddles” filed on Dec. 17, 2010 having application Ser. No. 61/424,518.

### FIELD

In general, a photovoltaic system having a two-axis tracker assembly for a photovoltaic system is discussed.

### BACKGROUND

A two-axis tracker may break up its solar array for more efficient operation. A two axis tracker may be designed for easier of installation in the field.

### SUMMARY

Various methods and apparatus are described for a photovoltaic system. In an embodiment, angle mapping logic for a solar array of a two-axis tracker mechanism for the concentrated photovoltaic system is configured to facilitate a remotely initiated angle mapping process and then remotely diagnose movement and other pointing errors in the solar array on the two-axis solar tracker mechanism. The angle mapping logic is configured to use a set of test points centered around the angular coordinates that CPV cells contained in the solar array should be ideally positioned at relative to a current position of the Sun in order to achieve a highest power output from the solar array containing the CPV cells. Deviations in power produced in the set of test points of the angle mapping process and shapes of the plotted information provide diagnostics to indicate error locations and types of pointing errors present in the equipment in the solar array and in the two-axis tracker mechanism. Information from the angle mapping process is sent over a network to a remote server for analysis. The angle mapping logic may be implemented 1) as coded software on computing device readable medium, 2) as an electronic circuit, and 3) as any combination both, and generally is located within an integrated electronic housing for the two-axis solar tracker mechanism.

### BRIEF DESCRIPTION OF THE DRAWINGS

The multiple drawings refer to the embodiments of the invention.

FIGS. 1A and 1B illustrate diagrams of an embodiment of a two axis tracking mechanism for a concentrated photovoltaic system having multiple independently movable sets of concentrated photovoltaic solar (CPV) cells.

FIG. 2 illustrates a diagram of an embodiment of a central backend management server system remotely located over the Internet from the two axis tracker assembly, and a remote computing device.

FIG. 3 illustrates a diagram of an embodiment of angle mapping logic located in an integrated electronic housing for a two-axis solar tracker mechanism.

FIG. 4 shows the physical and electrical arrangement of modules loaded with CPV cells, and paddle pair assemblies with modules per paddle structure in a representative tracker unit.

FIG. 5 illustrates a diagram of an embodiment of an electrical string circuit of 300 Volts in a series parallel wiring arrangement within a given paddle.

FIG. 6 illustrates a diagram of an embodiment of angle mapping grid matrix using small degree changes in the Roll axis and Tilt axis to collect data for detecting pointing errors.

FIG. 7 illustrates a diagram of an embodiment of a group of CPV cells in a paddle structure at an angle with respect to the Sun

FIG. 8 illustrates a plot of an embodiment of the I-V (current to voltage) curve showing the maximum power point for a given angle of the group of CPV cells.

FIG. 9 illustrates a plot of pointing angle and its field of view cross-section of a single paddle.

FIG. 10 illustrates a plot of an embodiment of response contours of a single paddle.

FIG. 11 illustrates a diagram of an embodiment of a three dimensional model of the contours, the shape, and height of the model, which can all point to the existence of certain types of pointing errors in the solar array.

FIG. 12 illustrates a plot of an embodiment of the power contours of the acceptance angle mapping of the group of CPV cells undergoing the angle mapping process.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific cells, named components, connections, types of connections, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as a first inverter, may be made. However, the specific numeric reference should not be interpreted as a literal sequential order but rather interpreted that the first inverter is different than a second inverter. Thus, the specific details set forth are merely exemplary. The specific details may be varied from and still be contemplated to be within the spirit and scope of the present invention.

In general, various apparatus and methods are discussed for angle mapping logic located in an integrated electronic housing for a two-axis solar tracker mechanism configured to respond to a command to remotely initiate the angle mapping process to correct the angular coordinates for CPV cells contained in the solar array of the two-axis solar tracker mechanism from those generated by the Ephemeris calculation alone in order to achieve the highest power out of the CPV cells. The angle mapping logic is configured to conduct an angle mapping process in groups of CPV cells making up the solar array. A matrix of the CPV cells at different angles relative to the Sun is populated with data from calibration measurements of the actual power being generated by a power output circuit during an angle mapping process and the logic applies DNI measurements to normalize those measurements over a duration time of the angle mapping process of the entire solar array to determine any pointing errors in the angular coordinates for the each group of CPV cells being tested relative to the Sun (Sun-pointing accuracy). Information from the angle mapping process may be sent over a network to a remote server for analysis.

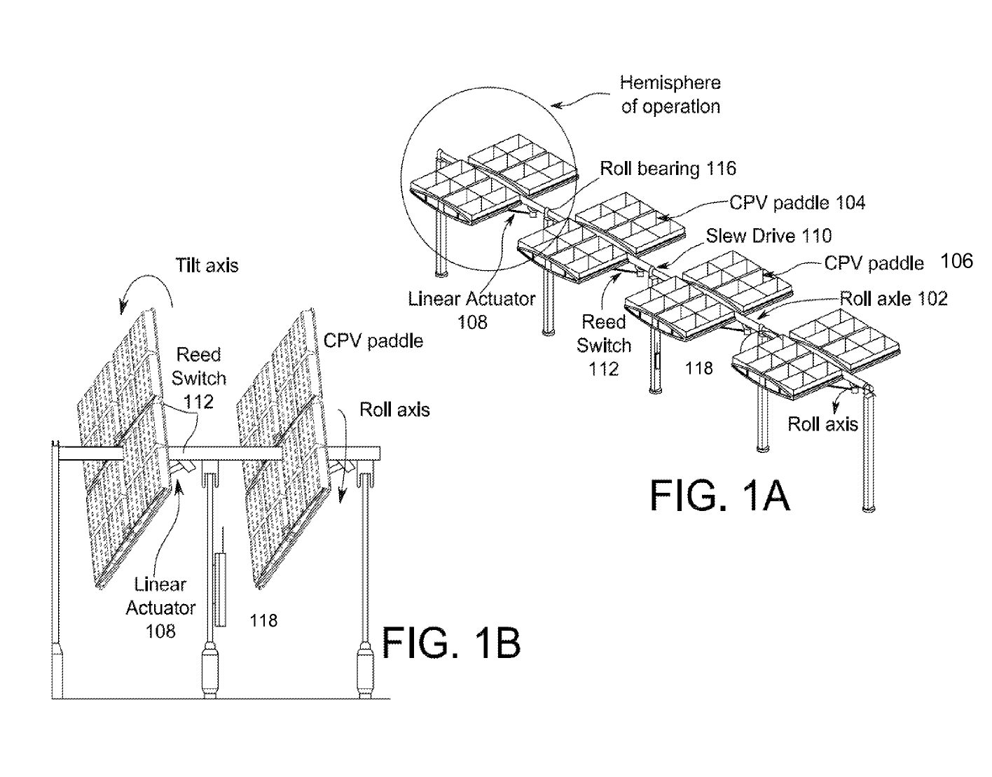

FIGS. 1A and 1B illustrate diagrams of an embodiment of a two axis tracking mechanism for a concentrated photovoltaic system having multiple independently movable sets of concentrated photovoltaic solar (CPV) cells. FIG. 1A shows the paddle assemblies containing the CPV cells, such as four paddle assemblies, at a horizontal position with respect to the common roll axle. FIG. 1B shows the paddle assemblies containing the CPV cells tilted up vertically by the linear actuators with respect to the common roll axle.

A common roll axle 102 is located between 1) stanchions, and 2) multiple CPV paddle assemblies. Each of the multiple paddle assemblies, such as a first paddle assembly 104, contains its own set of the CPV solar cells contained within that CPV paddle assembly that is independently movable from other sets of CPV cells, such as those in the second paddle assembly 106, on that two axis tracking mechanism. Each paddle assembly is independently moveable on its own tilt axis and has its own drive mechanism for that tilt axle. The drive mechanism may be a linear actuator with a brushed DC motor. An example number of twenty-four CPV cells may exist per module, with one to eight modules per CPV paddle, two or more CPV paddle structures per paddle assembly, a paddle assembly per tilt axis, and two to four independently-controlled tilt axes per common roll axis.

Each paddle pair assembly has its own tilt axis linear actuator, such as a first linear actuator 108, for its drive mechanism to allow independent movement and optimization of that paddle pair with respect to other paddle pairs in the two-axis tracker mechanism. Each tilt-axle pivots perpendicular to the common roll axle 102. The common roll axle 102 includes two or more sections of roll beams that couple to the slew drive motor 110 and then the roll beams couple with a roll bearing assembly having pin holes for maintaining the roll axis alignment of the solar two-axis tracker mechanism at the other ends, to form a common roll axle 102. The slew drive motor 110 and roll bearing assemblies are supported directly on the stanchions. A motor control board in the integrated electronics housing 118 on the solar tracker causes the linear tilt actuators and slew drive motor 110 to combine to move each paddle assembly and its CPV cells within to any angle in that paddle assembly's hemisphere of operation. Each paddle assembly rotates on its own tilt axis and the paddle assemblies all rotate together in the roll axis on the common roll axle 102.

The tracker circuitry in the integrated electronics housing 118 uses primarily the Sun's angle in the sky relative to that solar array to move the angle of the paddles to the proper position to achieve maximum irradiance. A hybrid algorithm determines the known location of the Sun relative to that solar array via parameters including time of the day, geographical location, and time of the year supplied from a local GPS unit on the tracker, or other similar source. The two-axis tracker tracks the Sun based on the continuous latitude and longitude feed from the GPS and a continuous time and date feed. The hybrid algorithm will also make fine tune adjustments of the positioning of the modules in the paddles by periodically analyzing the power (I-V) curves coming out of the electrical power output circuits to maximize the power coming out that solar tracker.

The hybrid solar tracking algorithm resident in the integrated electronics housing 118 supplies guidance to the motor control board for the slew drive and tilt actuators to control the movement of the two-axis solar tracker mechanism. The hybrid solar tracking algorithm uses both 1) an Ephemeris calculation and 2) an offset value from a matrix to determine the angular coordinates for the CPV cells contained in the two-axis solar tracker mechanism to be moved to in order to achieve a highest power out of the CPV cells. The matrix can be populated with data from periodic calibration measurements of actual power being generated by a power output circuit of the two-axis solar tracker mechanism and applies Kalman filtering to those measurements over time of the operation of the solar tracking mechanism to create an offset value from the matrix applied to results of the Ephemeris calculation to determine the angular coordinates for the CPV cells. The motion control circuit is configured to move the CPV cells to the determined angular coordinates resulting from the offset value being applied to the results of the Ephemeris calculation.

Angle mapping logic may be located within the integrated electronics housing 118 as well. The remotely initiated angle mapping process for autonomous characterization and optimization of CPV Array performance may be a multiple step process, such as 10 steps. As discussed, two or more pieces of equipment, such as modules, paddles, etc. make up the solar array. Two or more pieces of equipment such as a roll axle, a tilt axle, a roll bearing, etc. make up the two axis tracker mechanism. Each concentrated photovoltaic (CPV) solar array consists of a large number of individual solar power units (focusing optics+solar cell) organized into groups of CPV cells in 1) one or more modules, 2) one or more paddle structures, 3) one or more paddle pair assemblies, or 4) one or more string circuits of CPV cells. The modules are organized into multiple paddle pair assemblies that are kept pointed at the Sun by this multi-axis tracker assembly. The angle mapping logic is configured to cooperate with other routines and electronic circuits built into the two axis tracker assembly. The remotely initiated angle mapping process uses the routines and electronic circuits built into the two axis tracker assembly to allow a rapid assessment of the power conversion efficiency, acceptance angle and Sun-pointing accuracy of the various paddles containing the modules making up a solar array of the two axis tracker mechanism, and a rapid assessment of the field installation alignment of the paddles relative to each other and relative to the required Sun-pointing accuracy. The angle mapping procedure can be initiated both locally from a mobile control station at the multiple axis tracker assembly installation as well as remotely initiated.

The angle mapping process may be the ability to step groups of solar power units contained in 1) one or modules making up the solar array, 2) a string of CPV cells electrically strung together for the solar array feeding an inverter circuit for that two axis tracker 3) a paddle structure of the solar array 4) a paddle pair assembly composed of two or more paddle structures or 5) any combination of the four making up each solar array through a grid of pointing directions with different off-axis offsets from the Sun while performing a maximum power point (MPP) characterization of that group in the solar array at each grid point. The array may be part of a larger steerable group of arrays or may be steered independently of other solar arrays located at the same site. The larger steerable group of solar arrays would be located at the same site and may undergo the angle mapping process all at the same time.

In an example, four or more paddles, each contains a set of CPV cells, and form a part of the two-axis solar tracker mechanism. Each of these paddles may be part of a paddle pair assembly that rotates on its own tilt axis. For example, both a first paddle structure containing CPV cells on a first section of a first tilt axle and a second paddle structure containing CPV cells on a second section of the first tilt axle rotate on the axis of that first tilt axle. Likewise, both a third paddle structure containing CPV cells on a first section of a second tilt axle and a fourth paddle structure containing CPV cells on a second section of the second tilt axle rotate on the axis of that second tilt axle. In addition, both the first and second tilt axles connect perpendicular to the common roll axle that universally rotates all of the tilt axles.

The two-axis tracker includes a precision linear actuator for each of the paddle pairs in the four paddle pairs joined on the shared stanchions as well as the slew drive connect to the common roll axle 102. A set of magnetic reed sensors can be used to determine reference position for tilt linear actuators to control the tilt axis as well as the slew motor to control the roll axis on the common roll axle 102. Each tilt linear actuator may have its own magnetic reed switch sensor, such as a first magnetic reed sensor 112.

Each paddle pair has its own tilt axis linear actuator to allow independent movement and optimization of that paddle pair with respect to other paddle pairs in the tracker assembly. The tilt actuators and the slew drive motor control the position of the tilt and roll angles of the paddles to orient the CPV cells such that the maximum incoming light is focused to the photovoltaic collectors/receivers in the paddle pair.

The remotely initiated angle mapping process for autonomous characterization and optimization of CPV Array performance may be a multiple step process, such as 10 steps.

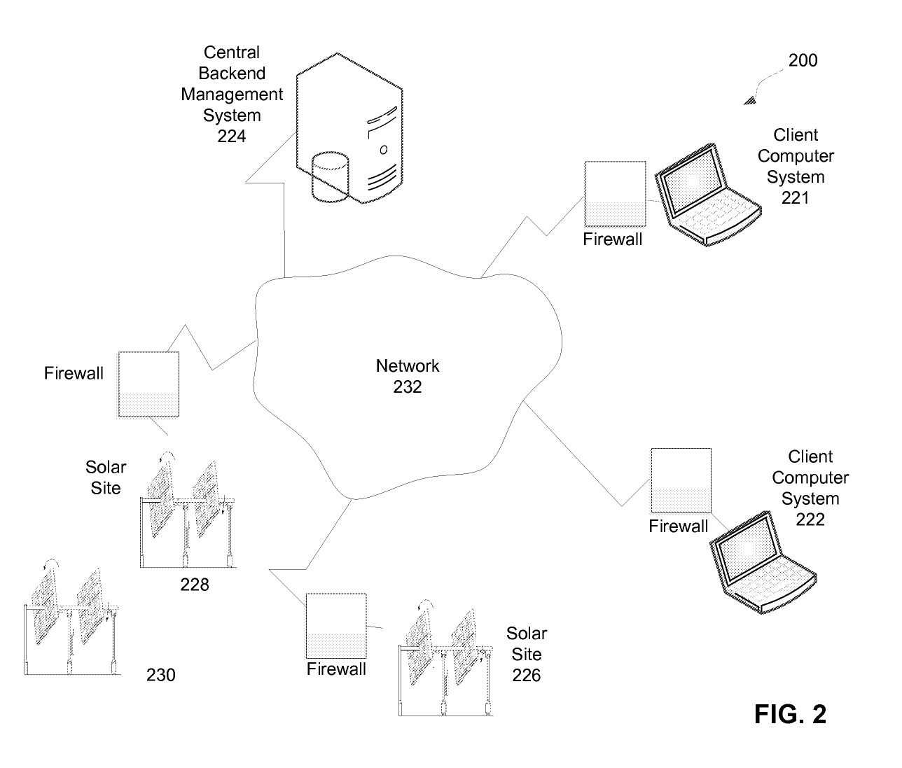

FIG. 2 illustrates a diagram of an embodiment of a central backend management server system remotely located over the Internet from the two axis tracker assembly, and a remote computing device. In step 1 of the remote angle process, a browser from a remote user's computing device 221, 222, including lap top, desk top, smart phone, etc. contacts the central backend management server system 224. The central backend management server system 224 presents a graphic user interface to the browser. The user actives icons on the user interface and selects category tabs to drill down in the user interface to select a given two axis tracker in the multitude of two axis trackers. A user in the service tab of the user interface may schedule a time to perform the remote angle mapping procedure on regular occurring basis, such as every month or bi-annually, annually etc., for this two axis tracker. The user may schedule a time to perform the remote angle mapping procedure on regular occurring basis on the multitude of two axis trackers, which may conduct the remote angle mapping procedure on all of the two axis trackers in parallel or sequentially to minimize the impact on power produced at the site, or select to manually initiate the remote angle procedure on the given two axis tracker at this time.

A processing scripted routine in the central backend management server 224 is configured to receive a request to initiate the angle mapping process from the graphic user interface and to translate the request into a command initiation request to be sent to the angle mapping logic of a single two axis tracker or angle mapping logic of a multitude of two axis trackers at the same site and transmits the command request at the specified time. Thus, the first multiple axis tracker 226 may conduct the angle mapping process by itself, and in contrast, the second multiple axis tracker 228 and the third multiple axis tracker 230 may conduct the angle mapping process in parallel. A transmission scripted routine in the central backend management server system 224 encrypts and sends the command initiation request over a wide area network 232, such as the Internet, to the System Control Point (SCP)/integrated electronics housing of each two axis tracker being requested perform the remote angle mapping procedure. The angle mapping logic, which may be software coded in a computing machine readable medium, hardware coded in an electronic circuit, or any combination of both is embedded in the SCP within a card such as the main CPU board to receive commands from the central backend management server system 224 and look up/decode the proper actions to take. The angle mapping logic may be located within an integrated electronic housing or at least on site for the two-axis solar tracker mechanism.

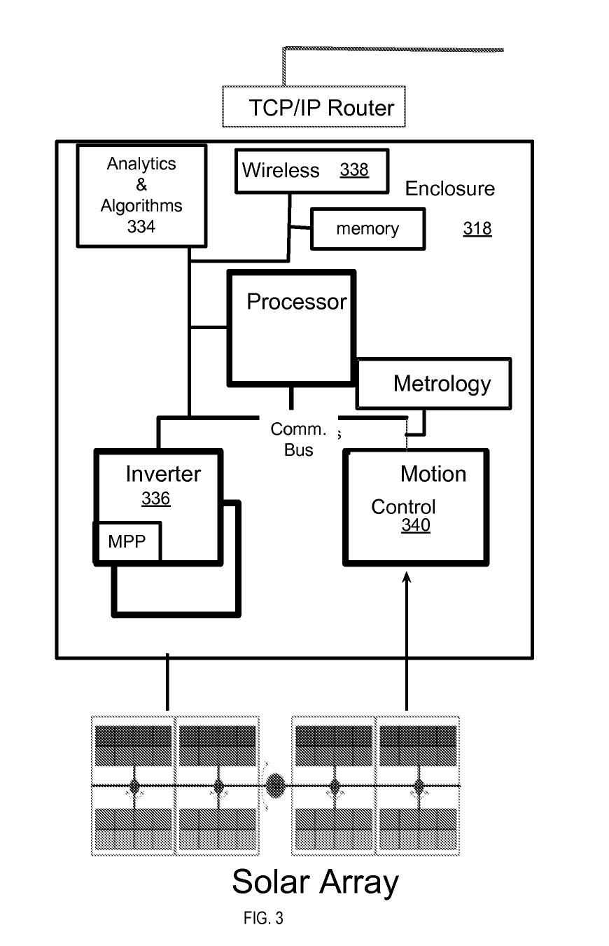

FIG. 3 illustrates a diagram of an embodiment of angle mapping logic located in an integrated electronic housing for a two-axis solar tracker mechanism. In step 2 of the remote angle process, the angle mapping logic in the SCP 318 is configured to grab data including DNI data for the last set period of time, day of the year and time of day, weather information, and other similar information. The angle mapping logic 334 ensures that the selected time to conduct the remote angle mapping procedure occurs only when/during Sun-viewing conditions are stable, avoids early morning/late evening, intermittent cloud coverage, strong winds, and other factors that could generate error prone data. The angle mapping logic 334 in the SCP the existence of local DNI meters at the site and their parameters being broadcast to that SCP, and/or through internet-available weather forecasts or observations, and some local time being tracked by a circuit in the SCP such as the CPU board and/or GPS circuitry. The angle mapping logic 334 monitors these DNI, weather, etc. parameters from the beginning of the remote angle mapping procedure on the first grid point in the angle mapping matrix to the data collected after performing the last grid point in the angle mapping matrix and checks these parameters against specific thresholds to ensure the collected data was grabbed on when the Sun-viewing and pointing conditions were stable. The remote angle mapping procedure takes a long time to perform.

The angle mapping logic 334 is configured to respond to a command to remotely initiate an angle mapping process to correct angular coordinates for CPV cells contained in the solar array of the two-axis solar tracker mechanism from those generated by an Ephemeris calculation alone in order to achieve the highest power out of the CPV cells. The angle mapping logic 334 is configured to conduct an angle mapping process in groups of CPV cells making up the solar array. A matrix of the CPV cells at different angles relative to the Sun is populated with data from calibration measurements of an actual power being generated by a power output circuit 336 during an angle mapping process and the angle mapping logic applies DNI measurements to normalize those measurements over a duration time of the angle mapping process of the entire solar array to determine any pointing errors in the angular coordinates for each group of CPV cells relative to the Sun. Thus, the angle mapping logic 334 is configured to use measured electrical power out of the inverter circuits 336 for the two axis tracker assembly and then factor in measured direct normal incidence of solar radiation at that two axis tracker mechanism at the time the electrical power measurement is made, such as dividing the actual measured electrical power by the direct normal incidence at the time the measurement is made, to determine the normalized electrical power out of the two axis tracker assembly.

In step 3 of the remote angle process, the angle mapping logic 334 sends a signal to the inverters 336 in the System Control Point (SCP) 318 for the tilt and roll tracker assembly to be characterized as disabled for the purpose of AC power generation. For example, the output contacts of the inverters 336 going to the utility grid may be opened or the three phase AC Output switching circuit may be powered off. However, electrical parameters such as DC current and voltage measurements being supplied to the inverter circuit 336, or AC power being generated from the inverter circuit 336, will be captured in a memory in the local electronics housing 318 in the multiple axis tracker assembly and sent eventually wirelessly 338 to the central backend server.

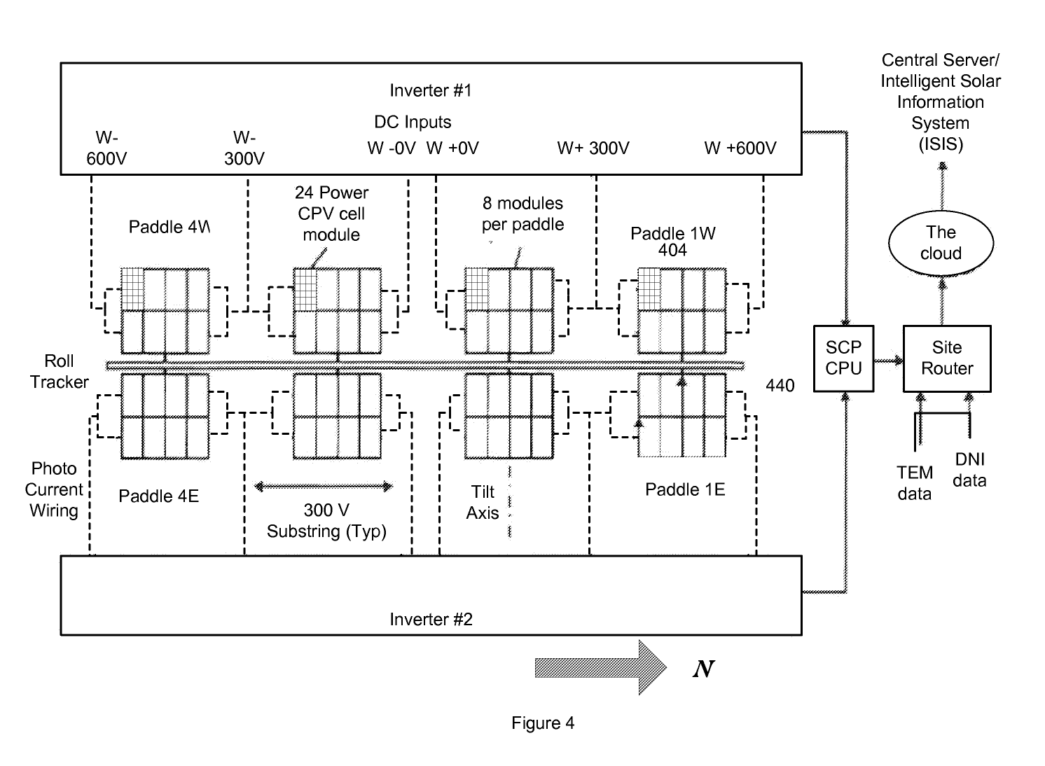

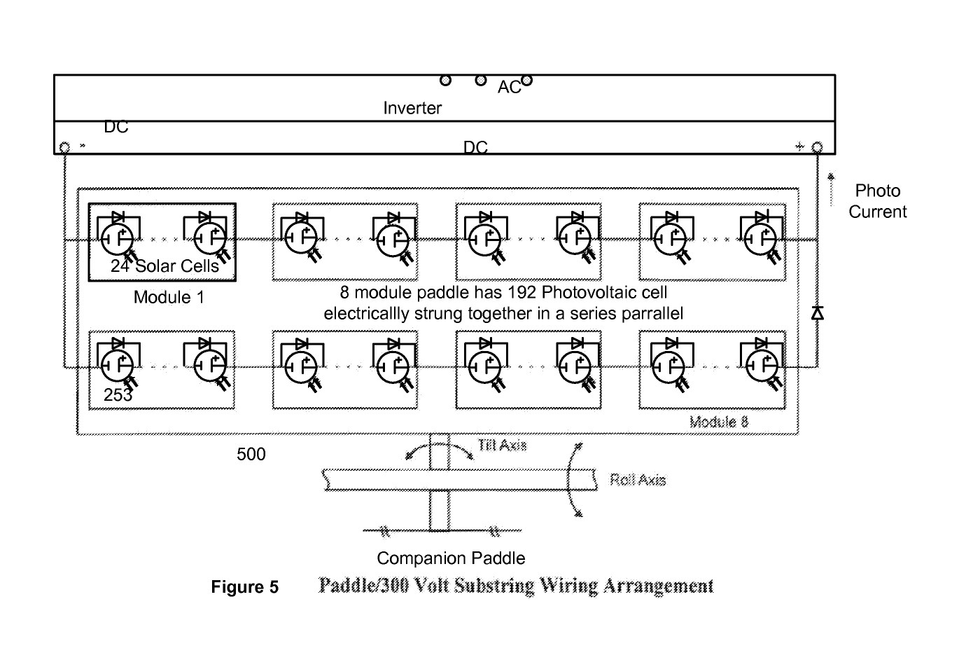

FIG. 4 illustrates a diagram of an embodiment of the establishment of electrical string circuits in a representative two axis tracker assembly arrangement. FIG. 5 illustrates a diagram of an embodiment of an electrical string circuit of 300 Volts in a series parallel wiring arrangement within a given paddle.

The test may be performed on a granularity of groups of CPV cells. The group may be all of the paddle pair assemblies making a solar array for the tracker 440, but generally is more on the granularity of an individual paddle structure in the solar array for the tracker, such as a first paddle structure 404, a set of two or modules, or even at each electrical string circuit of CPV cells feeding the one or more inverters for that two axis tracker.

The solar powered array construction may include the following installation features. The electrical connection of solar cells may be organized into separate string circuits (strings) such that each string circuit is confined to a mechanically ganged (“rigid”) array of modules in one or more paddle structures, such as a first 300 volt string from the first paddle structure 404. Each module has multiple solar power units. There may be several such string circuits of CPV cells per solar array. In an embodiment, however, a given string circuit of solar cells may span over two or more paddle structures on a same solar array but not span over two or more solar arrays. Thus, when the strings are being tested, then the source of problem can be more easily narrowed down to specific paddle structures on a single solar array.

When testing at the granularity of a paddle, then the individual pointing error of the paddle is then measured. When testing at the granularity of a string circuit of CPV cells, then the individual pointing error of the string circuit of CPV cells is then measured. When testing at the granularity of a module, then the individual pointing error of the module is then measured. For example then within a module, the optical axis of each power unit has a pointing error, relative to an established module mechanical datum surface, ranging from effectively zero up to an established manufacturing tolerance. These errors may be temperature-dependent. The constituent solar cells are typically wired in series. For design characterization purposes, the individual cell outputs can be made accessible so that the individual pointing errors can be measured via spatial mapping.

Note, it is not practically feasible to provide individual test set up wiring to each of the hundreds or thousands of solar cells in a field installation. Also, the granularity of control is at the paddle pair assembly level rather than on a solar power unit level. The testing at higher levels of granularity and having test points built into the circuitry to perform this angle mapping procedure provides many benefits as discussed later.

FIG. 4 shows the physical and electrical arrangement of modules loaded with CPV cells, and paddle pair assemblies with modules per paddle structure in a representative tracker unit. Here, there are 24 solar power units (CPV cells and focal lens) per module, one to eight modules per paddle structure, two or more paddle structures per paddle pair assembly on the tilt axis, and two to four independently-controlled tilt axes per common roll axis. The solar cells in each string circuit are wired in the series-parallel arrangement as shown in FIG. 5.

Although each paddle pair assembly constitutes a “rigid” array as defined above, confining each independently measurable string to a single paddle structure allows the assessment non-rigid characteristics between paddles such as axle flexure and paddle sag. Multiple paddle structures on the same side of the two axis tracker may also constitute a measurable string of CPV cells. The angle mapping process depends on partitioning the solar cells into groups, such as 300 V substrings, in order to independently assess each group of strings/paddles/or arrays during angle mapping. Partitioning the solar cells into 300 V substrings may be also done for power management purposes.

Referring to FIG. 3, in step 4 of the remote angle process, the angle mapping process uses equipment built into the two-axis tracker assembly. In the following examples, the angle mapping process equipment is built into the two axis tracker assembly. The data collected from 1) the power out of the inverter circuit 336 or 2) the power supplied to the inverter circuit 336 and then is stored in a memory for that two axis tracker assembly. In the alternative, the actual power unit pointing offset from the Sun at each step can be determined by a precision pointing system or optionally by an optical Sun-viewing tracker error monitor (TEM) that is rigidly attached to the power unit. The angle mapping logic 334 is configured to assemble collected parameters from the angle mapping process and compress that data for wireless transmission to a router on a Local Area Network for this solar site to be transmitted over the Internet to the remote server. Note when the electrical test points collect these data points by built in circuits of the electronics in the SCP, then the test points built into the inverter circuitry 336, the angle mapping logic 334 to conduct this test, a local memory built into the local electronics, and wireless circuitry 338 built into the two axis tracker assembly cooperate to transmit this information to the remote server, and thus, eliminates the purchase of additional test equipment generally need to conduct an angle mapping test.

The angle mapping logic 334 is configured to send a signal to one or more inverter circuits 336 to have its built in Maximum Power Point sense circuit to perform MPP sweeps of a string circuit of solar cells supplying DC power to that inverter circuit 336, and a motion control circuit 340 steers a tilt axis drive and roll axis drive to move the string circuit of solar cells in response to the MPP sweeps.

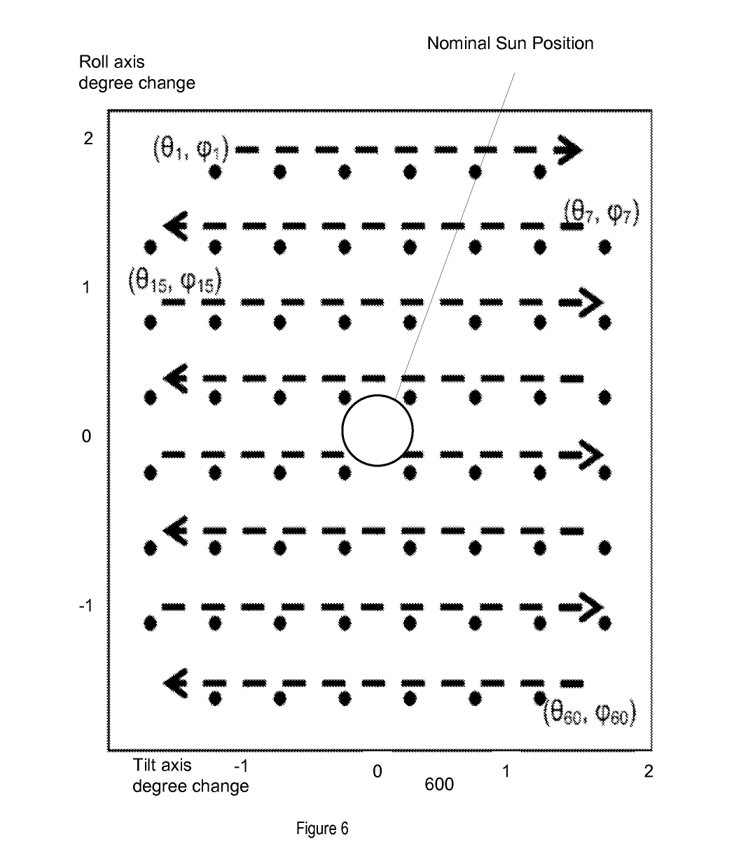

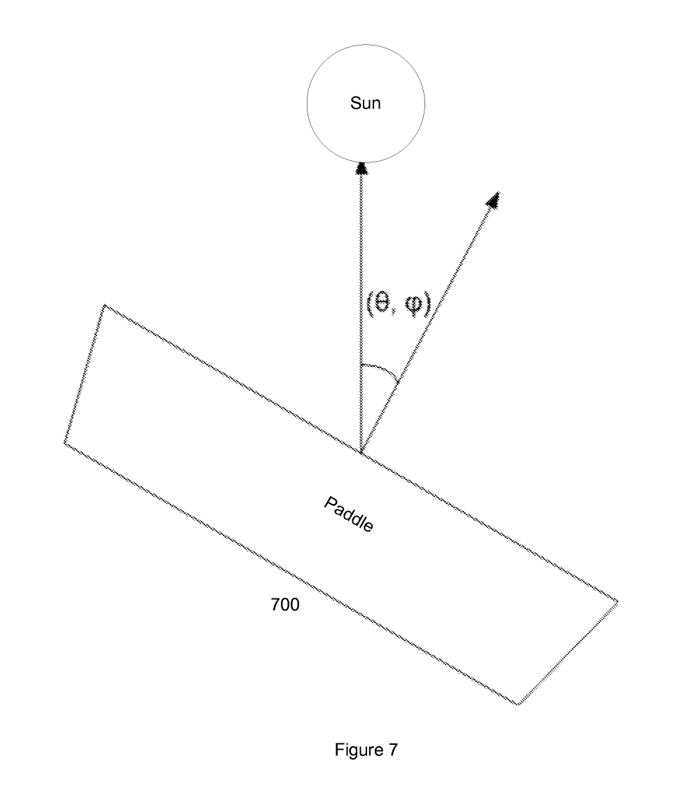

FIG. 7 illustrates a diagram of an embodiment of a group of CPV cells in a paddle structure at an angle with respect to the Sun. FIG. 6 illustrates a diagram of an embodiment of angle mapping grid matrix using small degree changes in the Roll axis and Tilt axis to collect data for detecting pointing errors.

Referring to FIG. 6, a 64 point angle mapping grid matrix uses 0.5 degree increments of Roll axis degree change and Tilt axis degree change. The mapping algorithm has a range of deviation of test points from a starting angle that occurs around 2 degrees off from the nominal for this paddle. The IV Curve of the paddle structure or string circuit of CPV cells is taken at a series of angle offsets (θ1, φ1), . . . (θN, φN). Thus, the angle mapping grid matrix may have a sweep of multiple (i.e. 64) test points in ˜0.5° steps for a range of +/−2.0 degrees from when the circuits believe the paddle is ideally on Sun and located at 0.0 degrees in the grid. See FIG. 7, the pointing angle (θ deg, φ deg.) deviates from −2.0, −1.0, 0, +1.0, to +2.0 degrees from the ideal angular coordinate.

The angle mapping logic facilitates this remotely initiated angle mapping process and the later remotely diagnosing movement and other pointing errors in the solar array on the two-axis solar tracker mechanism. The angle mapping logic is configured to use the set of test points centered around the angular coordinates that CPV cells contained in the solar array should be ideally positioned at relative to a current position of the Sun to achieve a highest power output from the solar array containing the CPV cells. Later, deviations in power produced in the set of test points of the angle mapping process and shapes of the plotted information provide diagnostics to indicate error locations and types of pointing errors present in the equipment in the solar array and in the two axis tracker mechanism.

In step 5 of the remote angle process, the angle mapping logic uses tilt axis and roll axis position controllers to step all of the paddles in the solar array through an angle mapping grid such as shown in FIG. 6. The angle mapping grid consists of a matrix of angular coordinates deviated/offset of the nominal ideal angular coordinates to produce maximum power for that paddle at that time of day and day of the year, that the paddles will be driven to for each point in the matrix. The logic supplies the determined angular coordinates from the angle mapping algorithm to the motion control circuit to cause the CPV cells to move to these determined angular coordinates. The motion control circuit transforms the local coordinates into Roll and Tilt Tracker Angles.

The angle mapping logic ensures that the measured electrical characteristics, such as actual power output from the AC generation inverter circuits taken off the (I-V) curves, or measured DC voltage supplied to the inverter circuit, is taken with the set of two or more calibration points in a matrix. The logic makes sure that this measured data including electrical current, electrical voltage, and current DNI parameters corresponding to that time of day when the actual power output was measured, is recorded into the memory. All of these parameter values being stored in the memory in the SCP, are later transmitted over a wide area network to the remote server.

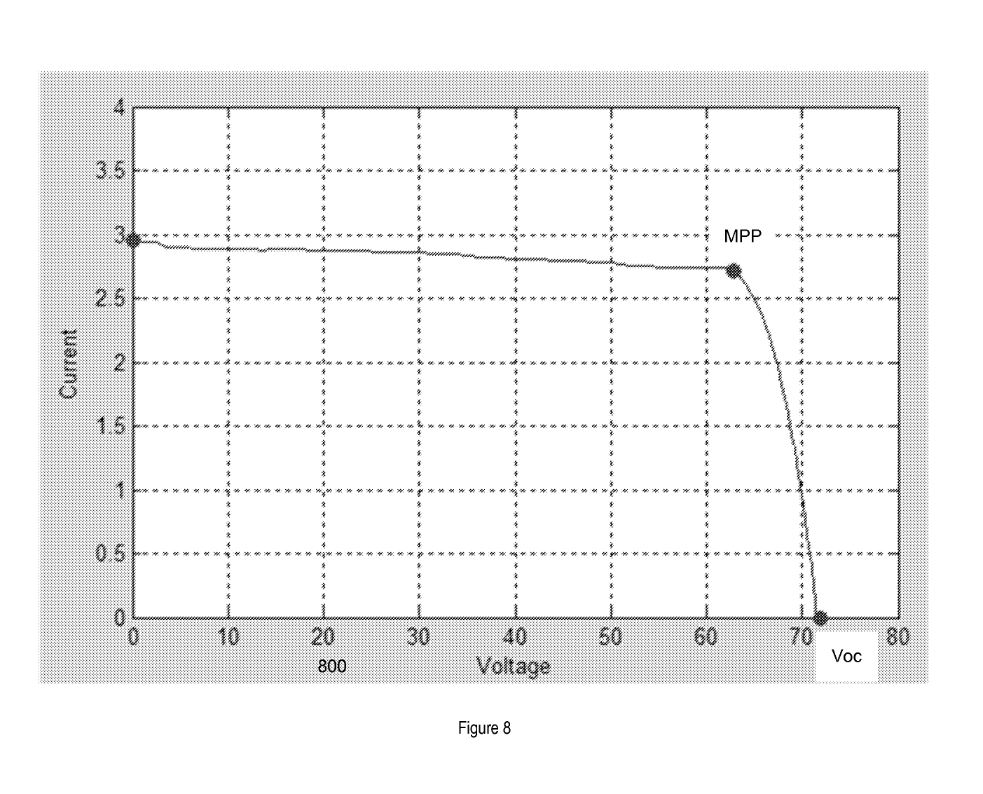

FIG. 8 illustrates a plot of an embodiment of the I-V (current to voltage) curve showing the maximum power point for a given angle of the group of CPV cells. In step 6 of the remote angle process, at each grid location, the substring performance parameters (short circuit current, open circuit voltage, MPP current, MPP voltage, and consequently MPP power), and DNI data (direct+circumsolar intensity) (if available) is collected and stored in the memory of the SCP. The example grid matrix in FIG. 6 consists of 64 offset points from the ideal angular coordinates to achieve max power from the paddle. Accordingly, the above substring performance parameters are collected 64 times and stored. The plot of the (I-V current-voltage curve) current and voltage measurements, short circuit current (i.e. about 3 amps), open circuit voltage (i.e. about 72 volts), MPP current, MPP voltage (i.e. about 2.8 amps at 62 volts), at each grid point in FIG. 6 is recorded. If all of the paddles are being tested in parallel, then 8 sets of the 64 points with multiple data parameters, one set for each paddle on the tracker, is collected and stored in the memory of the local electronics housing in that multiple axis tracker assembly. Each time the motion control board moves the paddle to a new offset coordinate, then the logic lets the conditions stabilize to achieve the maximum power from the paddle, and then records the above data parameters for that grid test point in the matrix. The angle mapping logic may then assemble the collected parameters into a table format and compress that data for wireless transmission over the Internet to the central backend management server system. The logic at the end of the testing makes sure the environmental conditions did not change past the threshold tolerances and actually transmits most of those parameters so their slight deviations from grid point to grid point can be factored into the ultimate analysis.

The example I-V Curve shows parameters of string voltage, electrical current, Max Power Point (MPP) which equals highest pairing of current times voltage, volts cold (Voc)=72V, amps short circuited (Isc)=2.95 A. As expected, the module's open-circuit voltage (Voc) is the sum of the cell Voc's (in this case, average cell Voc is approx. 72/24=3.0 V). However, the current is that of the least productive cell in the module. This cell could be under-performing due to solar cell efficiency, cell damage, fouling of the optics, and/or optical misalignment vs. the module's mechanical datum surface. This limitation exists so long as the under-performing cell generates enough voltage to reverse bias the associated blocking diode. By extension, the current in each group of CPV cells under test, such as a four-module branch of the paddle-level substring shown in FIG. 8, is limited by its least productive solar cell.

In step 7 of the remote angle process, the above steps of the angle mapping process are optionally repeated for each group of cells, i.e. each paddle structure, each paddle pair assembly on a given axle, or other such subsets. Generally, a high level test on each array as a whole unit will be performed. For each array in the multitude of arrays at the site that seems to be underperforming compared to the results of the other arrays at the site, then small groups of CPV cells can be tested such as individual paddle structure test and individual strings from a given paddle test in order to provide further information to determine the source of the problem at that array. The angle mapping logic at an end of the angle mapping process is configured to make sure environmental conditions during the angle mapping process did not change past threshold tolerances and then transmits environmental parameters so their slight deviations during the process can be factored into the ultimate analysis. The steps are optionally repeated for each roller tracker at the installation undergoing the angle mapping process in parallel.

In step 8 of the remote angle process, at the end of a data collection phase of the angle mapping process for a given two axis tracker assembly, the tilt and roll tracker and its inverter circuits are reconfigured for normal power production. If multiple trackers are being tested in parallel, the step to restore is repeated for each roller tracker at the installation undergoing the angle mapping process.

Referring to FIG. 2, in step 9 of the remote angle process, a scripted routine in the central backend management server system receives the compressed and transmitted data from each SCP at the site conducting the remote angle mapping testing. A scripted routine in the central backend management server system creates graphs and plots of the acquired data and also analyzes acquired data. Additionally, the peak substring responses are normalized using the DNI and temperature data to determine the parameter of peak power generation independent of pointing errors. The peak power measurement uses measured electrical power out of the inverter circuits of the solar tracker and then factors in measured direct normal incidence of solar radiation at that two axis tracker mechanism at the time the electrical power measurement is made, such as dividing the actual measured electrical power by the direct normal incidence at the time the measurement is made, to determine the highest power out of the solar tracker. An Acceptance angle function may be constructed for the paddle/string being tested using the measured angle offset position, and Pmax from the I-V Curve, and divided by DNI at time of test.

As discussed, the scripted routine in the remote server receives the transmitted data from the angle mapping logic and then generates shapes and plots of the data. The scripted routine determines pointing errors from the shapes of the graphs and plots of a given paddle of the solar array relative another paddle on the same two axis tracker assembly, or even relative to other two axis tracker assemblies in that same row of two axis tracker assemblies in the field of two axis tracker assemblies. The scripted routine is also configured to analyze absolute values of the received data parameters to also determine pointing errors.

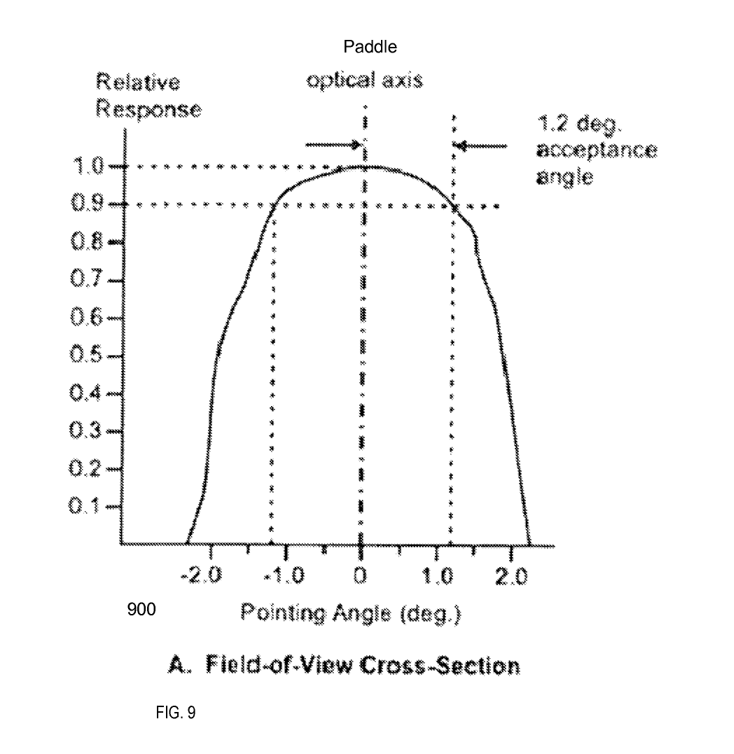

FIG. 9 illustrates a plot of pointing angle and its field of view cross-section of a single paddle.

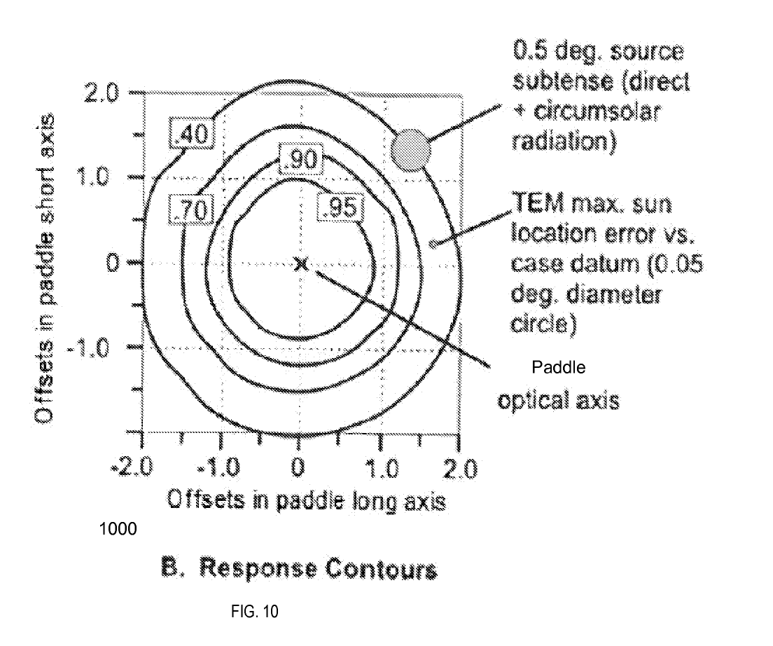

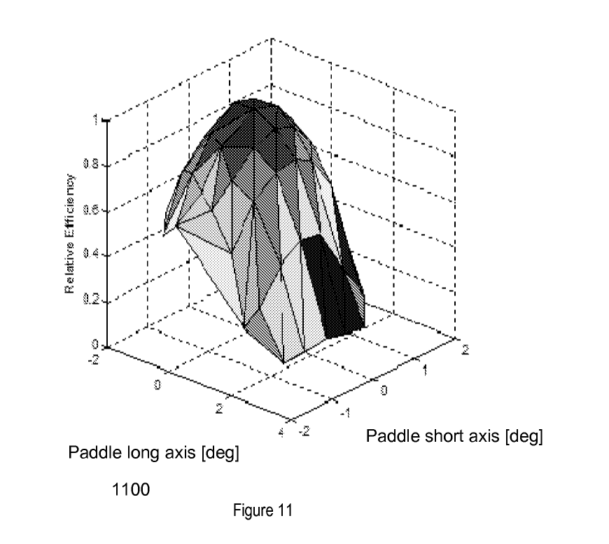

The angular response of a given solar power unit viewing the Sun can be represented as the cross-section of a nominally circular symmetric field-of-view. The acceptance angle may be the pointing error at which the solar cell power is 90% of on-axis peak. In the case shown, the acceptance angle design goal is 1.2 degrees. The logic may calculate the acceptance angle of a paddle/string. The logic may set the peak value to 1, and solve for the intersection of the acceptance function and the plane z=0.9. The radius of the 90% power contour is calculable to equal the acceptance angle. FIG. 10 illustrates a plot of an embodiment of response contours of a single paddle. The offsets in the paddle are plotted along the long and short axis of the paddle. The angle mapping response of a group of solar power units being tested, such as a string circuit or paddle being tested, may also be represented as a set of normalized-to-peak response contours as shown in FIG. 10. FIG. 11 illustrates a diagram of an embodiment of a three dimensional model of the contours, the shape, and height of the model, which can all point to the existence of certain types of pointing errors in the solar array. These contours can be constructed by stepping the pointing direction of the group of solar power units through a mapping grid such as shown in FIG. 6 and determining MPP at each grid point (angle mapping). The actual power unit pointing offset from Sun at each step can be determined by sending the data back to the remote server for analysis. The software then may generate the example illustrated three dimensional model.

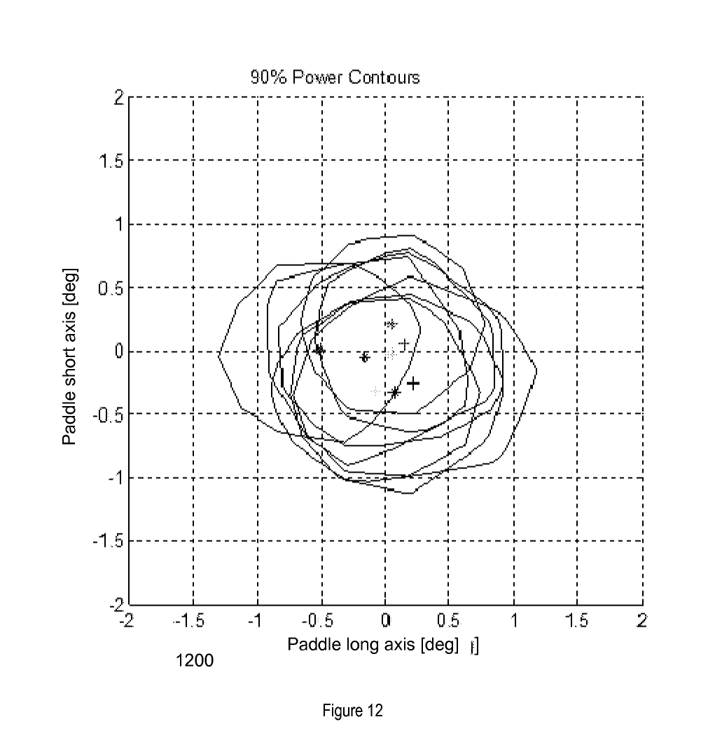

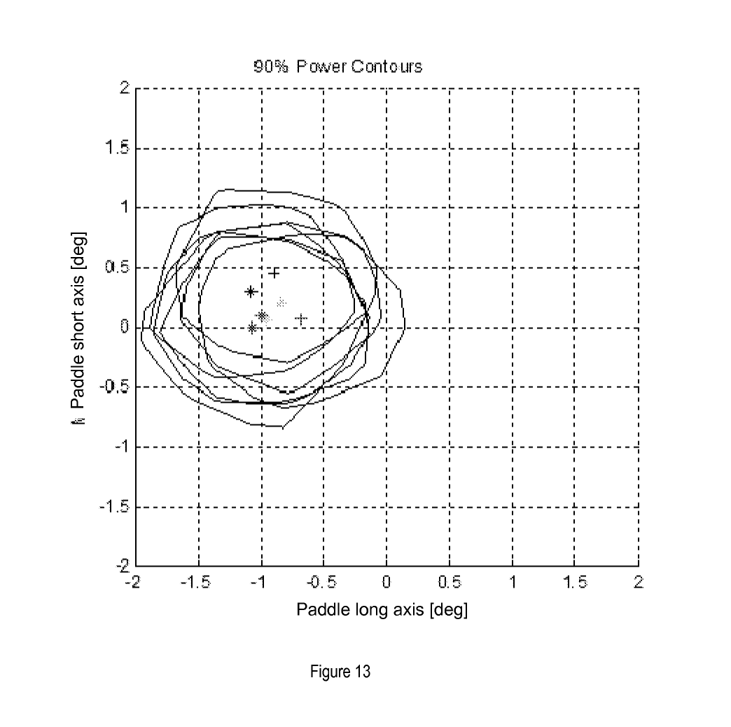

FIG. 12 illustrates a plot of an embodiment of the power contours of the acceptance angle mapping of the group of CPV cells undergoing the angle mapping process. The group of CPV cells, set of string circuits, paddles, modules, or whatever the granularity of the test has been selected in the user interface is compared with other groups of CPV cells. The comparison is in both how they compare to the expected ideal installation with no errors and how they compare other actual sets of string circuits or paddles or modules installed on that solar array. The example plot of these different groups of CPV cells being tested shows all groups of CPV cells have about the same shape centric around the ideal pointing. Ideally, each power contour would be stacked on top of one another, and all would be centered at (0, 0). However one group of CPV cells has its plot off center from the rest and is shifted slightly to the left from both the rest of the plotted CPV cells and the ideal plot centered around the 0, 0 coordinates of the plot. A potential pointing error would be investigated for this group of CPV cells.

When the group of CPV cells tested is a paddle structure, then the paddle pointing vector (each discrete paddle shown as an oval) may be the average of the 8 modules pointing vectors making up a paddle. One paddle seems to have an error by being offset to negative/left. FIG. 13 illustrates another plot of an embodiment of the power contours of the acceptance angle mapping the group of CPV cells undergoing the angle mapping process. All of the groups of CPV cells are aligned similarly to each other but the entire two axis tracker assembly alignment seems to be mechanically off with an error. All of the ovals of the CPV cells are offset to negative/left from the ideal pointing angle.

Referring to FIG. 2, in step 10 of the remote angle process, the central backend management server system 224 presents via the graphic user interface the plots and graphs of the angle mapping process to the browser of the user's computing device 221, 222, which is displayed on the display screen of the user's computing device 221, 222. In addition, a scripted routine in the central backend management server system 224 highlights abnormalities and provides suggestions to the user's computing device 221, 222 based on the acquired data analysis. For example, the following suggested actions might be taken:

Update tracker control compensation factors to reduce axis-dependent pointing errors.

Mechanical adjustment of the alignment of some of the components in the field (paddles, motors, modules, etc.)

Schedule site maintenance to diagnose and correct atypically low peak power performance (as might be caused by lens fouling or solar cell failures) and/or poor pointing performance (as might be caused by structural damage).

The system configuration described above entails a certain degree of diagnostic ambiguity, which can be made narrower by selecting a tighter group of CPV cells to be tested.

In step 10 of the remote angle process, the scripted routine in the central backend management server system also stores the remote angle mapping testing for each array and on each occasion the test is performed so historical and trend analysis may be performed on that acquired data.

The angle mapping diagnostic methods can be performed remotely on standard “production” CPV systems, without having to send anyone to the installation and without having to connect extra wiring or other hardware to the systems being characterized. The combination of the all these circuits being built in to each two axis tracker assembly at the site allows this test to be conducted much faster on an individual tracker basis as well as when groups of trackers are tested simultaneously, results in less downtime from the inverters producing power. The ability to initiate and monitor this test remotely saves tremendously in time and manpower. The ability conduct this test in parallel on multiple arrays or selectively on single arrays gives far more operational flexibility on how and when this test may be conducted. For example, the solar facility can still produce acceptable levels of power from arrays not undergoing the test and thus the operationally the test can be conducted when convenient. Similarly, if the solar site is being shut down for servicing all of the arrays can be tested roughly in parallel which makes the site test going much more rapidly than sequentially test each array with test equipment in the field. The stored historic data helps in evaluating what is causing a problem at an array and the automatic scheduling feature in the scripted code at the central server reduces the burden to schedule these servicing events.

Although the foregoing embodiments have been described in some detail for purposes of clarity of understanding, the invention is not limited to the details provided. The Solar array may be organized into one or more paddle pairs. Functionality of circuit blocks may be implemented in hardware logic, active components including capacitors and inductors, resistors, and other similar electrical components. There are many alternative ways of implementing the invention. The disclosed embodiments are illustrative and not restrictive.

We claim:

1. An apparatus, comprising:
angle mapping logic for a solar array of a two-axis tracker mechanism for a concentrated photovoltaic system to facilitate remotely initiating an angle mapping process and remotely diagnosing movement and other pointing errors in the solar array on the two-axis solar tracker mechanism, where two or more pieces of equipment make up the solar array, and two or more pieces of equipment make up the two axis tracker mechanism; and
where the angle mapping logic is configured to use a set of test points around angular coordinates that CPV cells contained in the solar array should be ideally positioned at relative to a current position of the Sun to achieve a highest power output from the solar array containing the CPV cells, and deviations in power produced in the set of test points of the angle mapping process provides diagnostics to indicate error locations and types of pointing errors present in the equipment in the solar array and in the two axis tracker mechanism, and information from the angle mapping process is sent over a network to a remote server for analysis, where the angle mapping logic is implemented as coded software on computing device readable medium, as an electronic circuit, and as any combination both and is located within an integrated electronic housing for the two-axis solar tracker mechanism.

2. The apparatus of claim 1, where the angle mapping logic is configured to cooperate with other routines and electronic circuits built into the two axis tracker assembly, and the remotely initiated angle mapping process uses the routines and electronic circuits built into the two axis tracker assembly to allow a rapid assessment of power conversion efficiency, acceptance angle and sun-pointing accuracy of various paddle structures making up the solar array of the two axis tracker mechanism.

3. The apparatus of claim 1, where the angle mapping logic is configured to step groups of solar power units contained in 1) one or modules making up the solar array, 2) a string of CPV cells electrically strung together for the solar array feeding an inverter circuit for that two axis tracker 3) a paddle structure of the solar array 4) a paddle pair assembly composed of two or more paddle structures or 5) any combination of the four making up each solar array through a grid of pointing directions with different off-axis offsets from the Sun while performing a maximum power point (MPP) characterization of that group in the solar array at each grid point.

4. The apparatus of claim 1, where the remote server has scripted code to initiate the angle mapping process on the solar array as part of a larger steerable group of solar arrays located at the same site undergoing the angle mapping process at the same time.

5. The apparatus of claim 1, where the remote server is a central backend management server system remotely located over the Internet from the two axis tracker assembly, and a browser from a remote user's computing device contacts the central backend management server system, and the central backend management server system presents a graphic user interface to the browser for the user to schedule a time to perform the remote angle mapping process for this two axis tracker.

6. The apparatus of claim 1, where the remote server is a central backend management server system remotely located over the wide area network from the two axis tracker assembly, and the central backend management server presents graphic user interface, and a processing scripted routine in the central backend management server is configured to receive a request to initiate the angle mapping process from the graphic user interface and to translate the request into a command initiation request to be sent to the angle mapping logic of a single two axis tracker or angle mapping logic of a multitude of two axis trackers at the same site, and a transmission scripted routine in the central backend management server system encrypts and sends the command initiation request over the wide area network to a System Control Point (SCP) of each two axis tracker assembly being requested perform the angle mapping procedure, where the angle mapping logic is embedded in the SCP to receive the command initiation request from the central backend management server system and decode any proper actions to take.

7. The apparatus of claim 1, where the angle mapping logic in the SCP of the two axis tracker assembly is configured to collect data including at least Direct Normal Incidence data, time of day, and weather information, where the angle mapping logic ensures that a selected time to conduct the remote angle mapping process occurs only when sun-viewing conditions are stable, including avoiding early morning and late evening, as well as intermittent cloud coverage, that could generate error prone data, where the angle mapping logic monitors these DNI, weather, and time parameters from a beginning of the remote angle mapping process until the data is collected after performing the angle mapping process and then checks these parameters against specific thresholds to ensure the collected data was grabbed when the sun-viewing and pointing conditions were stable.

8. The apparatus of claim 1, where the angle mapping logic is configured to use measured electrical power out of an inverter circuit for the two axis tracker assembly and then factor in measured direct normal incidence of solar radiation at that two axis tracker mechanism at the time the electrical power measurement is made to determine a normalized electrical power out of the two axis tracker assembly.

9. The apparatus of claim 1, where the angle mapping logic is built into the two axis tracker assembly, where data is collected from 1) a power out of an inverter circuit or 2) a power supplied to the inverter circuit and the data is stored in a memory for that two axis tracker assembly, and test points built into the inverter circuitry, the angle mapping logic to conduct this test, a local memory built into the local electronics, and wireless circuitry built into the two axis tracker assembly cooperate to transmit this information to the remote server.

10. The apparatus of claim 1, where the angle mapping logic is configured to send a signal to one or more inverter circuits to have its built in Maximum Power Point sense circuit to perform MPP sweeps of a string circuit of solar cells supplying DC power to that inverter circuit, and a motion control circuit steers a tilt axis drive and roll axis drive to move the string circuit of solar cells in response to the MPP sweeps.

11. The apparatus of claim 1, where the angle mapping logic is configured to take power measurements from built in circuitry in the two axis tracker assembly through a multiple test point grid using small degree incremental changes in the roll axis and tilt axis that deviate off from a nominal ideal angle for a paddle of the solar array under test, and tilt axis and roll axis position controllers in the two axis tracker assembly step the paddle through the multiple test point grid.

12. The apparatus of claim 1, where the angle mapping logic is configured to use measured electrical characteristics including actual power output from the AC generation inverter circuits taken off (I-V) curves, and the measured characteristics is taken with a set of two or more calibration points, where the logic makes sure that this measured data including electrical current, electrical voltage, and current DNI parameters corresponding to that time of day when the actual power output was measured, is recorded into the memory, and all of these parameter values being stored in the memory in the SCP, are later transmitted over the wide area network to the remote server.

13. The apparatus of claim 1, where the angle mapping logic is configured to assemble collected parameters from the angle mapping process and compress that data for wireless transmission to a router on a Local Area Network for this solar site to be transmitted over the Internet to the remote server, and the angle mapping logic at an end of the angle mapping process is configured to make sure environmental conditions during the angle mapping process did not change past threshold tolerances and then transmits environmental parameters so their slight deviations during the process can be factored into the ultimate analysis.

14. The apparatus of claim 13, where a scripted routine in the remote server is configured to receive the compressed and transmitted data from each SCP at the site conducting the remote angle mapping process, and a scripted routine in the remote server creates graphs and plots of the received data and then analyzes received data to indicate pointing errors.

15. The apparatus of claim 1, where a scripted routine in the remote server is configured to receive transmitted data from the angle mapping logic and generates shapes and plots of the data, and where the scripted routine determines pointing errors from the shapes of the graphs and the plots of the data of a given paddle of the solar array relative another paddle on the same two axis tracker assembly or even relative other two axis tracker assemblies in that same row of two axis tracker assemblies in a field of two axis tracker assemblies, where the scripted routine is also configured to analyze absolute values of the received transmitted data parameters to also determine pointing errors, and
where the remote server system presents a graphic user interface with the plots and graphs to a browser of a user's computing device, which is displayed on a display screen of the user's computing device.

16. An apparatus, comprising:
angle mapping logic for a solar array of a two-axis tracker mechanism for a concentrated photovoltaic system is configured to facilitate a remotely initiated angle mapping process and then remotely diagnose movement and other pointing errors in the solar array on the two-axis solar tracker mechanism, where deviations in 1) power produced in a set of test points of the angle mapping process and 2) shapes of the plotted information, provide diagnostics to indicate error locations and types of pointing errors present in equipment in a solar array and in its associated two-axis tracker mechanism, where a communication circuit sends information from the angle mapping process over a network to a remote server for analysis, and where the angle mapping process is initiated from the remote server.

17. An apparatus, comprising:
angle mapping logic located in an integrated electronic housing for a two-axis solar tracker mechanism is configured to respond to a command to remotely initiate an angle mapping process to correct angular coordinates for CPV cells contained in the solar array of the two-axis solar tracker mechanism from those generated by an Ephemeris calculation alone in order to achieve the highest power out of the CPV cells, where the angle mapping logic is configured to conduct an angle mapping process in groups of CPV cells making up the solar array, where a matrix of the CPV cells at different angles relative to the Sun is populated with data from calibration measurements of an actual power being generated by a power output circuit during an angle mapping process and the angle mapping logic applies DNI measurements to normalize those measurements over a duration time of the angle mapping process of the entire solar array to determine any pointing errors in the angular coordinates for each group of CPV cells relative to the Sun.

18. The apparatus of claim 17, where the angle mapping logic is configured to use measured electrical power out of an inverter circuit for the two axis tracker assembly and then factor in measured direct normal incidence of solar radiation at that two axis tracker mechanism at the time the electrical power measurement is made to determine a normalized electrical power out of the two axis tracker assembly.

19. The apparatus of claim 17, where the group of CPV cells undergoing the angle mapping process is selected to be all of the CPV cells in a paddle structure on the two axis tracker assembly.

20. The apparatus of claim 17, where the two-axis solar tracker mechanism is selected to be part of a group of two or more two-axis solar tracker mechanisms at the same site undergoing the angle mapping process at the same time.
